(19) United States
(12) Patent Application Publication
(10) Pub. No.: US 2023/0358670 A1
(43) Pub. Date: Nov. 9, 2023

(54) SINGLE-PHOTON-SPECTROSCOPIC ISOTOPE DETECTOR

(71) Applicant: RAYTHEON BBN TECHNOLOGIES CORP., Cambridge, MA (US)

(72) Inventor: Kin Chung FONG, Concord, MA (US)

(21) Appl. No.: 18/167,058

(22) Filed: Feb. 9, 2023

Related U.S. Application Data
(60) Provisional application No. 63/339,303, filed on May 6, 2022.

(51) Int. Cl. G01N 21/31

(52) U.S. Cl. CPC G01N 21/31; G01N 2201/0636; G01N 2201/06113

(57) ABSTRACT

A single-photon-spectroscopic isotope detector. In some embodiments, the isotope detector includes a narrow-band light source, and a single-photon detector. The narrow-band light source may be configured to generate light at a first wavelength near a second wavelength corresponding to a vibrational mode of a molecule including an isotope of interest.

### CROSS-REFERENCE TO RELATED APPLICATION(S)

The present application claims priority to and the benefit of U.S. Provisional Application No. 63/339,303, filed May 6, 2022, entitled “HIGH-SENSITIVITY ISOTOPE ANALYSIS BY SINGLE-PHOTON DETECTOR”, the entire content of which is incorporated herein by reference.

The present application is related to U.S. Pat. No. 9,577,176, entitled “JOSEPHSON JUNCTION READOUT FOR GRAPHENE-BASED SINGLE PHOTON DETECTOR”, the entire content of which is incorporated herein by reference.

### FIELD

One or more aspects of embodiments according to the present disclosure relate to measuring instruments, and more particularly to an isotope detector.

### BACKGROUND

The detection of isotopes has various applications, including commercial monitoring for radioactive isotopes in air or in water. For example, after a leak of nuclear material (e.g., from a power plant) it may be useful to monitor the air and sea water, near the location of the leak and in other parts of the world, for the presence of radioactive isotopes.

### SUMMARY

According to an embodiment of the present disclosure, there is provided a system, including: a narrow-band light source, and a single-photon detector, the narrow-band light source being configured to generate light at a first wavelength near a second wavelength corresponding to a vibrational mode of a molecule including an isotope of interest.

In some embodiments, the system further includes a reflector having a focus at a sample volume of the system.

In some embodiments, the system further includes a reflector having a focus at the single-photon detector.

In some embodiments, the system further includes: a reflector having a focus at a sample volume of the system; and a reflector having a focus at the single-photon detector.

In some embodiments: the reflector having a focus at a sample volume of the system is a parabolic reflector; and the reflector having a focus at the single-photon detector is a parabolic reflector.

In some embodiments, the narrow-band light source includes a laser.

In some embodiments, the laser includes a quantum cascade laser.

In some embodiments, the first wavelength is between 1.5 microns and 3 millimeters.

In some embodiments, the single-photon detector includes a graphene sheet for absorbing photons.

In some embodiments, the single-photon detector includes a Josephson junction for detecting a temperature change in the graphene sheet.

According to an embodiment of the present disclosure, there is provided a method, including: illuminating a sample, with a narrow-band light source, at a first wavelength near a second wavelength corresponding to a vibrational mode of a molecule including an isotope of interest; and measuring, using a single-photon detector, a flux of light from the sample.

In some embodiments, the method further includes placing the sample at a focus of a reflector.

In some embodiments, the single-photon detector is at the focus of a reflector.

In some embodiments, the method further includes placing the sample at a focus of a first reflector, wherein the single-photon detector is at the focus of a second reflector.

In some embodiments: the first reflector is a parabolic reflector; and the second reflector is a parabolic reflector.

In some embodiments, the narrow-band light source includes a laser.

In some embodiments, the laser includes a quantum cascade laser.

In some embodiments, the first wavelength is between 1.5 microns and 3 millimeters.

In some embodiments, the single-photon detector includes a graphene sheet for absorbing photons.

In some embodiments, the single-photon detector includes a Josephson junction for detecting a temperature change in the graphene sheet.

### BRIEF DESCRIPTION OF THE DRAWINGS

Features, aspects, and embodiments are described in conjunction with the attached drawings, in which:

FIG. 1 is a block diagram of an isotope detector, according to an embodiment of the present disclosure;

FIG. 2 is a schematic drawing of an isotope detector, according to an embodiment of the present disclosure;

FIG. 3A is a schematic drawing of an isotope detector, according to an embodiment of the present disclosure;

FIG. 3B is a schematic drawing of an isotope detector, according to an embodiment of the present disclosure; and

FIG. 3C is a schematic drawing of an isotope detector, according to an embodiment of the present disclosure.

### DETAILED DESCRIPTION

The detailed description set forth below in connection with the appended drawings is intended as a description of exemplary embodiments of an isotope detector provided in accordance with the present disclosure and is not intended to represent the only forms in which some embodiments may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

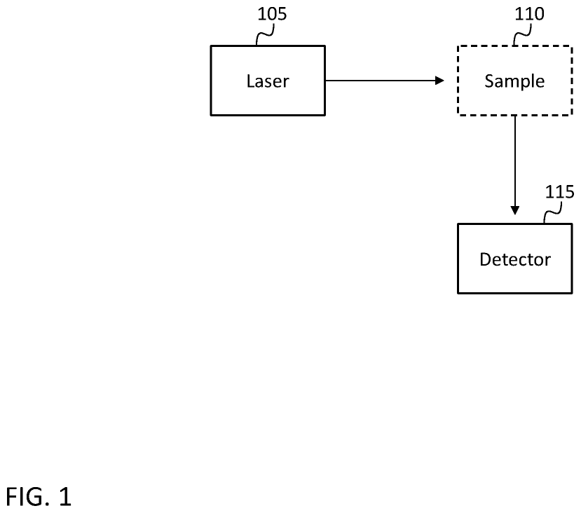

FIG. 1 is a block diagram of a system for detecting isotopes. A narrow-band light source 105 (e.g., a laser (e.g., a quantum cascade laser)) illuminates a sample 110. The sample may contain molecules (e.g., heavy water, such as hydrogen deuterium oxide (HDO)) containing an isotope of interest, such as deuterium. Such molecules may have a vibrational mode (e.g., a scissor mode, in the case of HDO) with a resonant frequency that is different from the corresponding vibrational mode of otherwise similar molecules that contain different isotopes (e.g., water (H₂O)).

For example, DOD may have a scissor mode frequency that is about 12% lower, than the scissor mode of HOD, HOD may have a scissor mode frequency that is about 11% lower, than the scissor mode of H₂O, and D-OR (where R=H or D) may have a vibrational mode frequency that is about 25% lower, than a corresponding vibrational mode of H—OR. The narrow-band light source 105 may be configured to emit light near (e.g., at) a wavelength corresponding to a resonant frequency of a vibrational mode of the molecule containing the isotope of interest (e.g., a wavelength near the ratio of the speed of light to the resonant frequency). This wavelength may be referred to as the resonant wavelength for the isotope of interest. The wavelength of the light produced by the narrow-band light source 105 may be between 1.5 microns and 3 millimeters. The light source may be the beating signal from two quantum cascade lasers. As used herein, when a first wavelength (e.g., the wavelength of light produced by the narrow-band light source 105) is described as being “near” a second wavelength, the second wavelength corresponding to a vibrational mode of a molecule including an isotope of interest, it means that the separation between the first wavelength and the second wavelength is a fraction between 0.01 and 0.95 of the full width at half maximum of the resonant absorption peak of the vibrational mode.

If molecules (e.g., heavy water molecules) are present, then the light from the light source may be scattered (e.g., absorbed and re-emitted) with a relatively high cross section. For examples, photons of the light from the light source may be resonantly absorbed by the molecules, causing each such absorbing molecule to transition to an excited state (of the resonant mode). Each such absorbing molecule may then, in a process of spontaneous emission, transition back to the ground state (of the resonant mode), emitting a photon having an energy equal to the difference between the energy of the excited state and the energy of the ground state.

Such scattered photons (e.g., each of the photons emitted by spontaneous emission from a molecule that absorbed, by resonant absorption, a photon from the narrow-band light source 105) may be detected by a sufficiently sensitive detector 115, and the detection of such photons may indicate the presence, in the sample 110, of the isotope of interest. If the isotope of interest is absent from the sample, photons may also be scattered from molecules in the sample (e.g., by non-resonant scattering) and detected by the detector 115, but the photon flux may be significantly lower.

In some embodiments, the photon flux at the detector 115 in the absence of the isotope of interest is measured in a calibration procedure (using a first calibration sample lacking the isotope of interest) and the photon flux measured in this calibration procedure (which may be referred to as background photon flux) is subtracted from the measured flux when measurements are made to determine whether the isotope of interest is present. In some embodiments, a second calibration sample, containing a known concentration of molecules including the isotope of interest, is used to measure the ratio of (i) the photon flux in excess of the background photon flux to (ii) the concentration of molecules including the isotope of interest. This ratio may then be used, when measurements are made to determine whether the isotope of interest is present, to calculate the concentration, in the sample, of molecules including the isotope of interest.

In some embodiments the wavelength of the narrow-band light source 105 is adjusted so that at a first point in time it is approximately (or exactly) equal to the resonant wavelength for the isotope of interest, and at a second point in time it is at an off-resonance wavelength significantly different from the resonant wavelength for the isotope of interest. The concentration, in the sample, of molecules containing the isotope of interest may then be inferred based on the change in photon flux between the first point in time and the second point in time. For example, the wavelength may be switched periodically back and forth between the resonant wavelength and the off-resonant wavelength, and the concentration, in the sample, of molecules containing the isotope of interest may be inferred based on a change in the photon flux that is periodic and synchronized with the changes in the wavelength of the narrow-band light source 105.

The sample may be a sample of gas (e.g., of the atmosphere) or a sample of liquid (e.g., sea water). In some embodiments the sample is held in a sample container (shown as a dashed line in FIG. 1); in other embodiments the entire system is filled with the atmospheric gas being tested, and the sample is the gas that is in a volume that is (i) illuminated by the narrow-band light source 105 and (ii) from which scattered photons are able to reach the detector 115.

The detector 115 may be a suitable single-photon detector, such as a detector including a graphene sheet for absorbing photons, and a Josephson junction for detecting the temperature change that occurs in the graphene sheet when a photon is absorbed. Such a detector is described, for example, in U.S. Pat. No. 9,577,176, entitled “JOSEPHSON JUNCTION READOUT FOR GRAPHENE-BASED SINGLE PHOTON DETECTOR”, the entire contents of which are incorporated herein by reference.

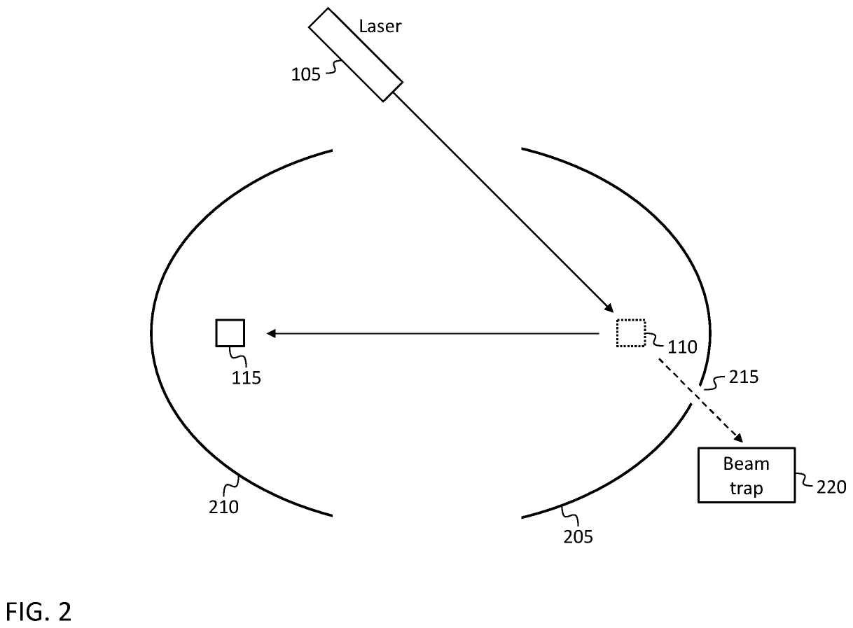

In some embodiments, an optical system, as shown in FIG. 2, may be used to increase the fraction of scattered photons that reaches the detector. As illustrated in FIG. 2 (which is not drawn to scale), a first reflector 205 (which may be, e.g., a parabolic reflector, e.g., a reflector having a reflective surface that is a circular paraboloid) may be used to collect the light scattered from the sample and direct this light toward a second reflector 210 (which may be, e.g., a parabolic reflector), which focuses the received light on the detector 115. In the embodiment of FIG. 2, the sample is at the focus of the first reflector 205 and the detector 115 is at the focus of the second reflector 210.

In some embodiments, a single ellipsoidal reflector (or two reflectors each being a portion of the same ellipsoid) is used instead of two parabolic reflectors. In such an embodiment, the sample may be at a first focus of the ellipsoidal reflector and the detector 115 may be at a second focus of the ellipsoidal reflector.

The light from the narrow-band light source 105 may enter the region between the first reflector 205 and the second reflector 210 through a gap between the first reflector 205 and the second reflector 210, as shown in FIG. 2. In some embodiments, an opening 215 in the first reflector 205 allows any light that is transmitted through the sample 110 (show as a dashed line in FIG. 2) to exit from within the first reflector 205, and to be absorbed by a beam trap 220, reducing the background photon flux that otherwise might result from scattering at the point at which the light from the narrow-band light source 105 would reflect from the first reflector 205, and from additional scattering along the path of the light from the narrow-band light source 105. In some embodiments, the light from the narrow-band light source 105 instead enters the region in the first reflector 205 through an opening 215 in the first reflector 205 and the light that is transmitted through the sample 110 exits through a gap between the first reflector 205 and the second reflector 210 (e.g., the light travels along the same path as that illustrated in FIG. 2, in the opposite direction from the direction illustrated in FIG. 2).

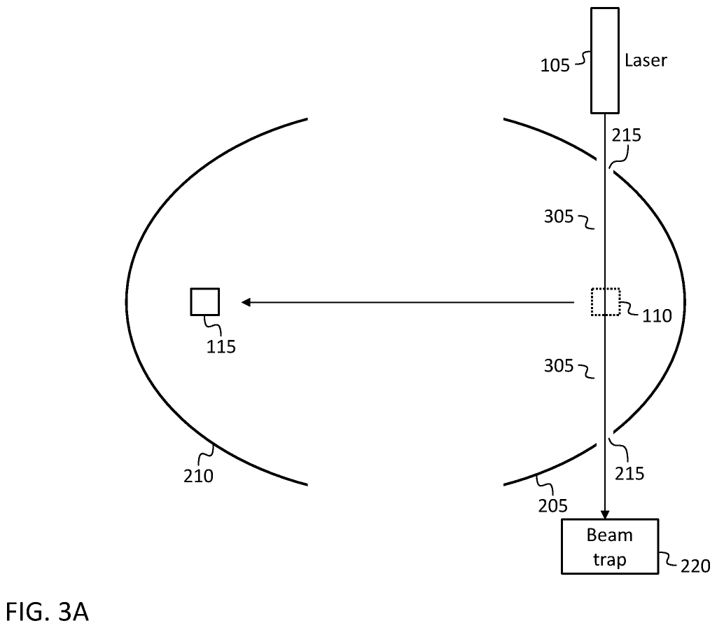

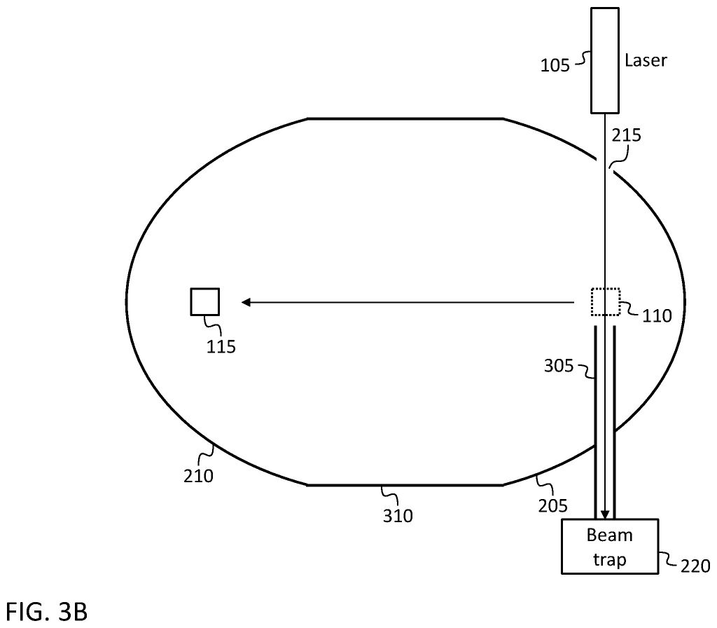

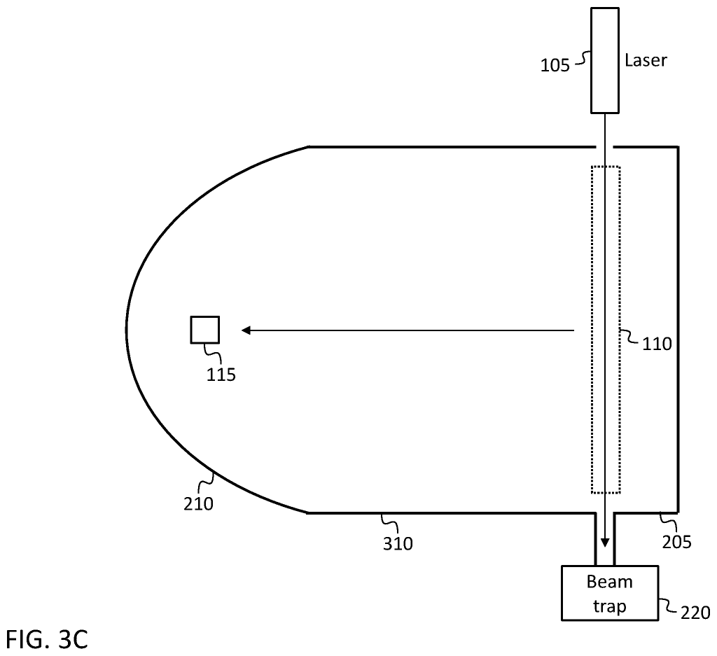

Referring to FIG. 3A, in some embodiments, the light from the narrow-band light source 105 enters the region in the first reflector 205 through an opening 215 and the light that is transmitted through the sample 110 exits through another opening 215. In some embodiments, as shown in FIG. 3B, the first reflector 205 is optically sealed to the second reflector 210 by an opaque tube 310, and a baffle 305 (e.g., an opaque tube with a non-reflective interior surface) may reduce the extent to which light from outside the first reflector 205 and the second reflector 210 (e.g., light reflecting from the beam trap 220) is able to reach the detector 115.

In some embodiments the optical system may be arranged differently. For example, a lens may be used to focus the light scattered from the sample on the detector, instead of reflectors such as those shown in FIGS. 3A and 3B. In some embodiments the sample volume is an elongated volume extending along a significant length of the beam produced by the narrow-band light source 105, as illustrated in FIG. 3C. In such an embodiment, the first reflector 205 may have the shape of a parabolic trough having the sample volume at its focal line, and the tube 310 may have (i) a rectangular end for sealing against the first reflector 205, and a round (e.g., circular) end for sealing against the second reflector 210.

In some embodiments, it is not necessary to perform measurements off line; for example, it is not necessary to collect a sample, transfer the sample to an instrument, and analyze the sample to determine whether the isotope of interest is present. Instead, in some embodiments an isotope detector may be a system capable of being implemented on line. For example, atmospheric air may be pumped continuously through the sample volume, testing for the isotope of interest may be performed continuously, and an alarm may be triggered if the concentration of the isotope of interest exceeds a threshold. Similarly, sea water may be pumped continuously through the sample volume, and an alarm may be triggered if the concentration of an isotope of interest exceeds a threshold.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, the word “or” is inclusive, so that, for example, “A or B” means any one of (i) A, (ii) B, and (iii) A and B.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1− 35/100) times 10) and the recited maximum value of 13.5 (i.e., (1+ 35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Although limited embodiments of an isotope detector have been specifically described and illustrated herein, many modifications and variations will be apparent to those skilled in the art. Accordingly, it is to be understood that an isotope detector employed according to principles of this disclosure may be embodied other than as specifically described herein. Features of some embodiments are also defined in the following claims, and equivalents thereof.

What is claimed is:

1. A system, comprising:
a narrow-band light source, and
a single-photon detector,
the narrow-band light source being configured to generate light at a first wavelength near a second wavelength corresponding to a vibrational mode of a molecule including an isotope of interest.

2. The system of claim 1, further comprising a reflector having a focus at a sample volume of the system.

3. The system of claim 1, further comprising a reflector having a focus at the single-photon detector.

4. The system of claim 1, further comprising:
a reflector having a focus at a sample volume of the system; and
a reflector having a focus at the single-photon detector.

5. The system of claim 4, wherein:
the reflector having a focus at a sample volume of the system is a parabolic reflector; and
the reflector having a focus at the single-photon detector is a parabolic reflector.

6. The system of claim 1, wherein the narrow-band light source comprises a laser.

7. The system of claim 6, wherein the laser comprises a quantum cascade laser.

8. The system of claim 1, wherein the first wavelength is between 1.5 microns and 3 millimeters.

9. The system of claim 1, wherein the single-photon detector comprises a graphene sheet for absorbing photons.

10. The system of claim 9, wherein the single-photon detector comprises a Josephson junction for detecting a temperature change in the graphene sheet.

11. A method, comprising:
illuminating a sample, with a narrow-band light source, at a first wavelength near a second wavelength corresponding to a vibrational mode of a molecule including an isotope of interest; and
measuring, using a single-photon detector, a flux of light from the sample.

12. The method of claim 11, further comprising placing the sample at a focus of a reflector.

13. The method of claim 11, wherein the single-photon detector is at the focus of a reflector.

14. The method of claim 11, further comprising placing the sample at a focus of a first reflector, wherein the single-photon detector is at the focus of a second reflector.

15. The method of claim 14, wherein:
the first reflector is a parabolic reflector; and
the second reflector is a parabolic reflector.

16. The method of claim 11, wherein the narrow-band light source comprises a laser.

17. The method of claim 16, wherein the laser comprises a quantum cascade laser.

18. The method of claim 11, wherein the first wavelength is between 1.5 microns and 3 millimeters.

19. The method of claim 11, wherein the single-photon detector comprises a graphene sheet for absorbing photons.

20. The method of claim 19, wherein the single-photon detector comprises a Josephson junction for detecting a temperature change in the graphene sheet.
